(19) United States
(12) Patent Application Publication
(10) Pub. No.: US 2024/0419807 A1
(43) Pub. Date: Dec. 19, 2024

(54) SECURITY ANALYSIS APPARATUS, SECURITY ANALYSIS METHOD, AND COMPUTER READABLE RECORDING MEDIUM

(71) Applicant: NEC Corporation, Minato-ku, Tokyo (JP)

(72) Inventors: Junpei Kamimura, Tokyo (JP); Kazuhiko Isoyama, Tokyo (JP)

(73) Assignee: NEC Corporation, Minato-ku, Tokyo (JP)

(21) Appl. No.: 18/702,865

(22) PCT Filed: Oct. 29, 2021
(86) PCT No.: PCT/JP2021/040114

§ 371 Date: Apr. 19, 2024

(51) Int. Cl. G06F 21/57

(52) U.S. Cl. CPC G06F 21/577

(57) ABSTRACT

A security analysis apparatus includes a determination unit. The determination unit searches for information described in a data flow diagram of a computer system to be analyzed, using a search query corresponding to an analysis rule for use in analysis, and determines a relationship between the data flow diagram and the analysis rule based on retrieved information.

### TECHNICAL FIELD

The present invention relates to a security analysis apparatus and a security analysis method for performing security checks on a computer system, and further relates to a computer readable recording medium for realizing the apparatus and method.

### BACKGROUND ART

Many computer systems are connected via networks to external devices, and are exposed to external threats at all times. Thus, in the construction of a computer system, penetration testing, vulnerability diagnosis, platform diagnosis, and the like are conventionally performed.

In addition, Patent Document 1 discloses a method for efficiently developing a computer system while assessing the threat of cyberattack, for example. According to the method disclosed in Patent Document 1, a model is created based on design information of a target computer system, and data representing a threat is extracted from the model to assess the threat.

Further, a computer system may undergo security checks based on analysis rules. With such security checks, the analysis rules are preset according to the use purpose of the computer system. The analysis rules are set by NIST-SP800-53 (guidelines for enhancing the safety of information systems within the U.S. government and conducting effective risk management), PCI DSS (international standards for card information security), or the like, for example.

With the above-described security check, first, a data flow diagram (DFD) is generated based on the specification and operation history of the computer system. The data flow diagram is a diagram showing the flow of data in the computer system. Next, processing such as process (program) creation, file access, and communication that are performed in the computer system are hypothesized on the data flow diagram, based on the specification, use case, operation procedure, and the like. Then, it is determined whether the analysis rules are satisfied using the hypothesized processing.

Examples of the analysis rules include the following:
The IP address of a host that does not communicate externally is set to a private address.
Communications with external devices are performed through a proxy.
Unnecessary communications are filtered out.
The service network and the management network are separated from each other.

### LIST OF RELATED ART DOCUMENT

### Patent Document

Patent Document 1: Japanese Patent Laid-Open Publication No. 2017-68825

### SUMMARY OF INVENTION

### Problems to be Solved by the Invention

The above-described security check is usually performed by manually comparing the data flow diagram with the analysis rules, which is a large burden on the administrator of the computer system. In addition, since the analysis rules are generally described in a generic manner so as to be applicable to various systems and various use cases, it is difficult to automatize security checks using a computer.

An example object of the present disclosure is to provide a security analysis apparatus, a security analysis method, and a computer readable recording medium that enable automatization of security checks based on analysis rules in a computer system.

### Means for Solving the Problems

In order to achieve the above-described object, a security analysis apparatus according to an example aspect of the present disclosure includes:
a determination unit that searches for information described in a data flow diagram of a computer system to be analyzed, using a search query corresponding to an analysis rule for use in analysis, and determines a relationship between the data flow diagram and the analysis rule based on retrieved information.

In order to achieve the above-described object, a security analysis method according to an example aspect of the present disclosure includes:
searching for information described in a data flow diagram of a computer system to be analyzed, using a search query corresponding to an analysis rule for use in analysis; and
determining a relationship between the data flow diagram and the analysis rule based on retrieved information.

In order to achieve the above-described object, a computer readable recording medium according to an example aspect of the present disclosure is a computer readable recording medium that includes recorded thereon a program,
the program including instructions that cause the computer to carry out:
searching for information described in a data flow diagram of a computer system to be analyzed, using a search query corresponding to an analysis rule for use in analysis; and
determining a relationship between the data flow diagram and the analysis rule based on retrieved information.

### Advantageous Effects of the Invention

As described above, according to the present disclosure, it is possible to enable automatization of security checks based on analysis rules in a computer system.

### BRIEF DESCRIPTION OF THE DRAWINGS

FIG. 1 is a configuration diagram illustrating the schematic configuration of the security analysis apparatus according to the example embodiment.

FIG. 2 is a configuration diagram illustrating a specific configuration of the security analysis apparatus according to the example embodiment.

FIGS. 3A and 3B are diagrams illustrating examples of data flow diagrams that are used in the present example embodiment and differ from each other.

FIG. 4 is a diagram illustrating an example of a management table for use in the management of the data flow diagrams.

FIG. 5 is a diagram illustrating an example of a management table used by the rule management unit to manage the analysis rules in the example embodiment.

FIG. 6 is a flowchart showing operations of the security analysis apparatus of the example embodiment.

FIG. 7 is a configuration diagram illustrating a modification example of the security analysis apparatus in the example embodiment.

FIG. 8 is a block diagram illustrating an example of a computer that realizes the security analysis apparatus according to the example embodiment.

### EXAMPLE EMBODIMENT

### Example Embodiment

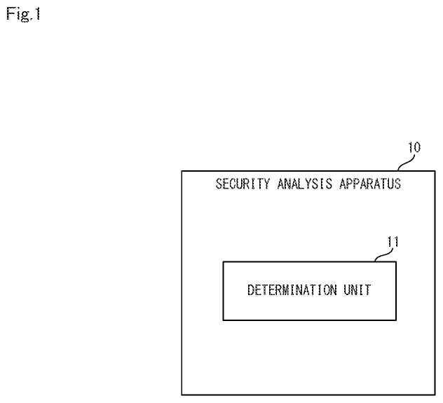

Hereinafter, a security analysis apparatus according to an example embodiment will be described with reference to FIGS. 1 to 8.

### Apparatus Configuration

First, a schematic configuration of a security analysis apparatus according to the example embodiment will be described with reference to FIG. 1. FIG. 1 is a configuration diagram illustrating the schematic configuration of the security analysis apparatus according to the example embodiment.

A security analysis apparatus 10 according to the example embodiment illustrated in FIG. 1 is an apparatus that performs security checks on a computer system. As illustrated in FIG. 1. the security analysis apparatus 10 includes a determination unit 11.

The determination unit 11 first uses a search query corresponding to an analysis rule for use in analysis to search for information described in a data flow diagram of the computer system to be analyzed. Then, based on the retrieved information, the determination unit 11 determines the relationship between the data flow diagram and the analysis rule.

As described above, the security analysis apparatus 10 can search the data flow diagram of the computer system and extract information related to analysis rules, and thus it is possible to automatize security checks based on analysis rules in the computer system.

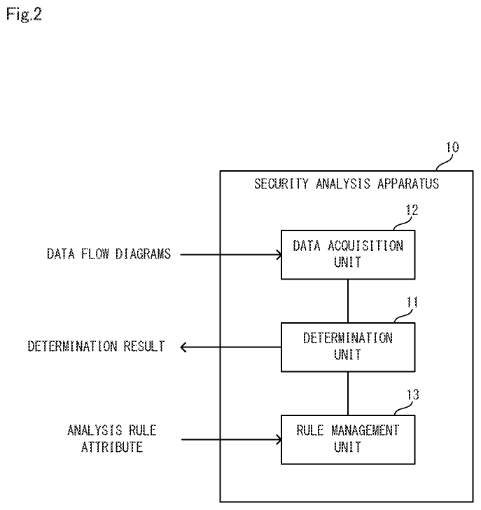

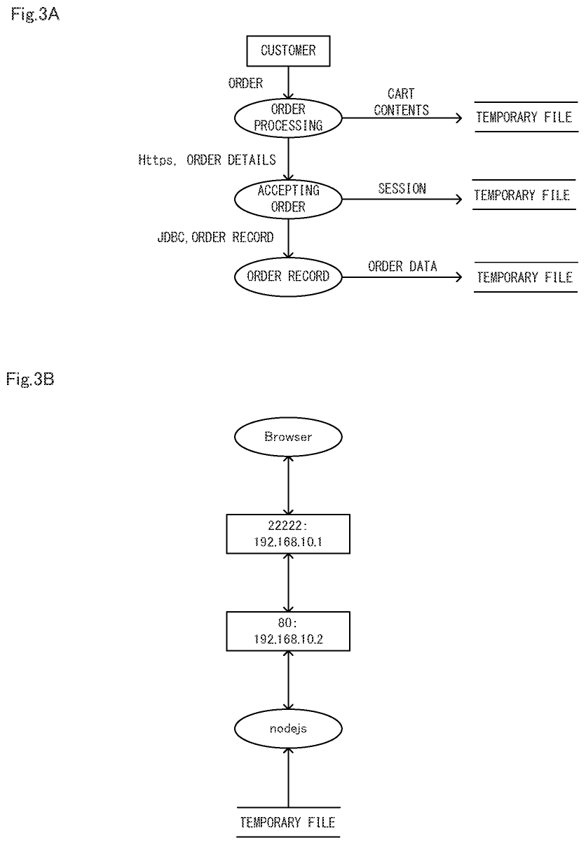

Subsequently, the security analysis apparatus 10 according to the example embodiment will be described more specifically with reference to FIGS. 2 to 5. FIG. 2 is a configuration diagram illustrating a specific configuration of the security analysis apparatus according to the example embodiment. FIGS. 3A and 3B are diagrams illustrating examples of data flow diagrams that are used in the present example embodiment and differ from each other.

As illustrated in FIG. 2, in the example embodiment, the security analysis apparatus 10 includes a data acquisition unit 12 and a rule management unit 13 in addition to the determination unit 11 described above. The data acquisition unit 12 acquires data flow diagrams of the computer system to be analyzed. The data flow diagrams may be created in advance manually or may be automatically created based on data acquired from the computer system to be analyzed.

The data flow diagrams are diagrams that visually represent the flow of data in the computer system as illustrated in FIGS. 3A and 3B. The data flow diagrams are constituted by a number of symbols. In FIGS. 3A and 3B, arrow symbols indicate a flow of data, and oval symbols indicate processes. Horizontal double-line symbols indicate data accumulation, and rectangular symbols indicate external systems (source or sink) that transmit or receive external data.

FIG. 3A illustrates a data flow diagram constituting an EC site in a computer system. FIG. 3B illustrates a data flow diagram for browser software to communicate with a web server.

In the example embodiment, the data acquisition unit 12 can acquire data flow diagrams from an external apparatus. The place from which data flow diagrams are acquired is not limited in particular. In the example embodiment, a data flow diagram is constructed for each test scenario of the computer system, and the data acquisition unit 12 acquires the data flow diagram for each test scenario. The test scenarios are created assuming actual operation of the computer system.

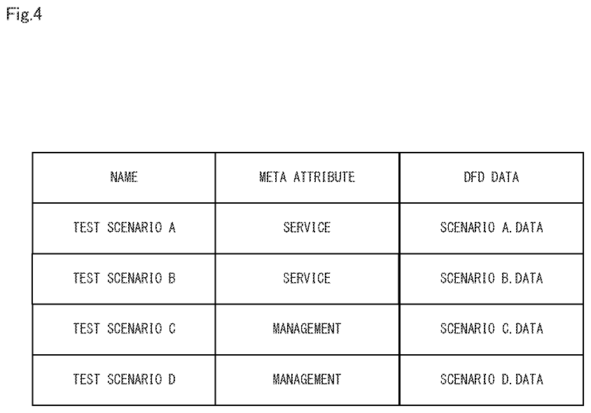

In the example embodiment, the data flow diagrams are managed at the acquisition place with a management table illustrated in FIG. 4. FIG. 4 is a diagram illustrating an example of a management table for use in the management of the data flow diagrams. As illustrated in FIG. 4, a data flow diagram is managed for each test scenario. The data flow diagrams are associated with attribute information, specifically, meta attributes, of the corresponding test scenarios. Therefore, the data acquisition unit 12 acquires the attribute information for each test scenario in addition to the data flow diagram created for each test scenario.

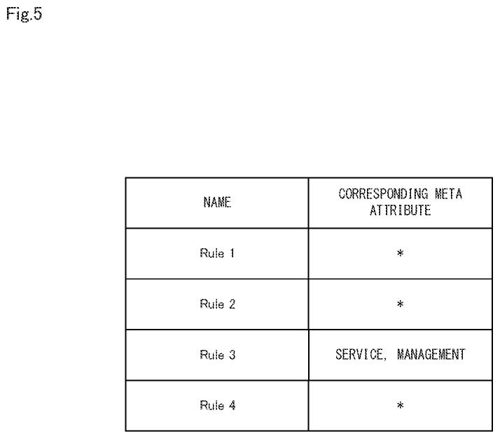

The rule management unit 13 manages preset analysis rules. In the example embodiment, the rule management unit 13 manages the preset analysis rules and attributes (meta attributes) added to the analysis rules in a management table. FIG. 5 is a diagram illustrating an example of a management table used by the rule management unit to manage the analysis rules in the example embodiment. As shown in FIG. 5, in the example embodiment, the user of the security analysis apparatus 10 inputs each analysis rule and corresponding attribute (meta attribute), and the rule management unit 13 receives the input analysis rule and attribute.

In the example embodiment, the determination unit 11 compares the attributes added to the analysis rules to be used for analysis with the attribute information for each test scenario, and determines a test scenario to be analyzed. The determination unit 11 then uses a search query to search the data flow diagram corresponding to the determined test scenario, and determines whether the data flow diagram is in violation of the analysis rule.

Determination processing performed by the determination unit 11 will be described with specific examples of analysis rules (Rule 1 to Rule 4).

### Rule 1

Rule 1 defines that “the IP address of a host that does not communicate externally is set to a private address”, for example.

First, the determination unit 11 specifies meta attributes corresponding to Rule 1 from the management table managed by the rule management unit 13. Since the meta attribute is “*” (see FIG. 5), the determination unit 11 determines all the test scenarios as test scenarios to be analyzed. Then, the determination unit 11 acquires the data flow diagrams (DFD data, see FIG. 4) corresponding to the test scenarios A to D from the data acquisition unit 12.

Subsequently; the determination unit 11 uses search queries corresponding to Rule 1 to cross-search all the data flow diagrams corresponding to the determined test scenarios A to D, and specifies a host that does not communicate externally.

A host that does not communicate externally here refers to a host having only a node or an edge that communicates with only a private address or a global IP address of the host within the system in the data flow diagrams. Therefore, the search queries in this case are global IP addresses and private addresses (0.0.0.0 to 10.255.255.255, 172.16.0.0 to 172.31.255.255, and 192.168.0.0 to 192.168.255.255).

The determination unit 11 then determines whether the specified host has a global IP address in any of the data flow diagrams. If the search result indicates that the specified host has a global IP address, the determination unit 11 determines that the data flow diagram in which the specified host is present is in violation of Rule 1.

### Rule 2

Rule 2 defines that “unnecessary communications are filtered out”, for example. In the following description, filtering for limiting the ports to be permitted to communicate with a firewall (FW) at the host level will be taken as an example. Under Rule 2, the determination unit 11 does not determine whether Rule 2 has been violated and generates information necessary for fulfilling security check items as the determination result.

First, the determination unit 11 specifies meta attributes corresponding to Rule 2 from the management table managed by the rule management unit 13. Since the meta attribute is “*” (see FIG. 5), the determination unit 11 determines all the test scenarios as test scenarios to be analyzed. Then, the determination unit 11 acquires the data flow diagrams (DFD data, see FIG. 4) corresponding to the test scenarios A to D from the data acquisition unit 12.

Subsequently; the determination unit 11 uses search queries corresponding to Rule 2 to cross-search all the data flow diagrams corresponding to the determined test scenarios A to D, and specifies protocol port numbers generated between hosts.

Here, the search queries in Rule 2 are search queries for specifying all pairs of nodes indicating IP ports that are in communication, except for protocol-independent ephemeral ports, for example.

The determination unit 11 then outputs the specified protocol numbers as permitted port numbers. The output port numbers are information necessary for fulfilling the security check items. Therefore, the user can fulfill the check item of filtering out unnecessary communications by prohibiting communications except for with the permitted port numbers that are obtained.

### Rule 3

Rule 3 defines that “the service network and the management network are separated”, for example.

First, the determination unit 11 specifies meta attributes corresponding to Rule 3 from the management table managed by the rule management unit 13. The meta attributes are “service and management” (see FIG. 5). Thus, the determination unit 11 groups the test scenarios according to the meta attributes, searches the corresponding data flow diagrams, per group, with search queries, compares the search results of the groups, and determines the relationship between the corresponding data flow diagrams and the analysis rule.

Specifically, the determination unit 11 first determines the test scenarios A and B as test scenarios with the meta attribute “service”. Then, the determination unit 11 acquires the data flow diagrams (DFD data, see FIG. 4) corresponding to the test scenarios A and B from the data acquisition unit 12.

The determination unit 11 then uses the search queries corresponding to Rule 3 to search the data flow diagrams corresponding to the test scenarios A and B, and creates a list of pairs of transmission IP addresses and reception IP addresses of past communications.

Subsequently, the determination unit 11 determines the test scenarios C and D as test scenarios with the meta attribute “management”. The determination unit 11 then acquires the data flow diagrams (DFD data, see FIG. 4) corresponding to the test scenarios C and D from the data acquisition unit 12.

Further, the determination unit 11 uses the search queries corresponding to Rule 3 to search the data flow diagrams corresponding to the test scenarios C and D, and creates a list of pairs of transmission IP addresses and reception IP addresses of past communications.

The search queries in Rule 3 are search queries for specifying all the pairs of transmission IP addresses and reception IP addresses that were used in processing related to “service” or “management”, for example.

Then, based on the list of pairs created in relation to the meta attribute “service” and the list of pairs created in relation to the meta attribute “management”, the determination unit 11 specifies the transmission IP addresses and the reception IP addresses contained in the both lists of pairs, and determines that the data flow diagrams including the specified transmission IP addresses and reception IP addresses are in violation of Rule 3.

### Rule 4

Rule 4 defines that “the direct use of an external DNS server is prohibited”, for example.

First, the determination unit 11 specifies meta attributes corresponding to Rule 4 from the management table managed by the rule management unit 13. Since the meta attribute is “*” (see FIG. 5), the determination unit 11 determines all the test scenarios as test scenarios to be analyzed. The determination unit 11 acquires the data flow diagrams (DFD data, see FIG. 4) corresponding to the test scenarios A to D from the data acquisition unit 12.

Subsequently, the determination unit 11 searches each of the data flow diagrams of the determined test scenarios A to D, and determines the relationship between the corresponding data flow diagrams and the analysis rule based on the retrieved information for each data flow diagram.

Specifically, the determination unit 11 searches each data flow diagram using search queries corresponding to Rule 4, and specifies the communication with an external DNS server.

The search queries in Rule 4 are search queries for specifying communications with external IP addresses via the port of a DNS server, for example.

If the determination unit 11 specifies communication with an external DNS server, the determination unit 11 determines that the corresponding data flow diagram is in violation of Rule 4.

### Apparatus Operations

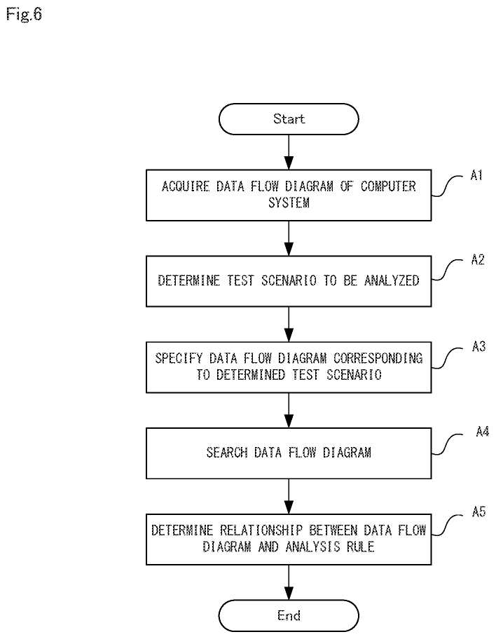

Next, operations of the security analysis apparatus 10 in the example embodiment will be described with reference to FIG. 6. FIG. 6 is a flowchart showing operations of the security analysis apparatus of the example embodiment. In the following description, FIGS. 1 to 5 will also be referred to as appropriate. In the example embodiment, a security analysis method is implemented by operating the security analysis apparatus 10. Therefore, description of the security analysis method of the example embodiment will be replaced by the following description of the operations of the security analysis apparatus 10.

As illustrated in FIG. 6, first, the data acquisition unit 12 acquires a data flow diagram of a computer system to be analyzed, for each test scenario, from an external apparatus (step A1).

Next, the determination unit 11 compares the attribute added to the analysis rule for use in analysis with the attribute information for each test scenario, and determines a test scenario to be analyzed (step A2).

The determination unit 11 then specifies the data flow diagram corresponding to the determined test scenario, among the data flow diagrams acquired in step A1 (step A3).

The determination unit 11 then searches the data flow diagram specified in step A3, using a search query corresponding to the analysis rule for use in analysis (step A4).

After that, based on the results of the search in step A4, the determination unit 11 determines the relationship between the data flow diagram specified in step A3 and the analysis rule (step A5).

If the analysis rule is Rule 1, 3, or 4 described above, for example, the determination unit 11 determines whether the data flow diagram is in violation of the analysis rule. If the analysis rule is Rule 2 described above, for example, the determination unit 11 generates information necessary for fulfilling the security check items, as the determination result.

In this manner, the security analysis apparatus 10 automatically searches data flow diagrams of the computer system using search queries corresponding to analysis rules, and extracts information related to the analysis rules. Then, the security analysis apparatus uses the extracted information to determine the relationship between the data flow diagrams and the analysis rules. Thus, according to the first example embodiment, it is possible to execute security checks based on analysis rules in the computer system, without human intervention.

### Program

A program in the example embodiment is any program that causes a computer to execute steps A1 to A5 shown in FIG. 6. The security analysis apparatus 10 and the security analysis method in the present example embodiment can be realized, by installing the program in the computer and executing the installed program. In this case, the processor of the computer functions as the determination unit 11, the data acquisition unit 12, and the rule management unit 13 to perform processing. The computer may be a general-purpose PC, a smartphone, or a tablet terminal device.

The program in the example embodiment may be executed by a computer system that is constructed of a plurality of computers. In this case, each computer may function as any of the determination unit 11, the data acquisition unit 12, and the rule management unit 13.

### Modification Example

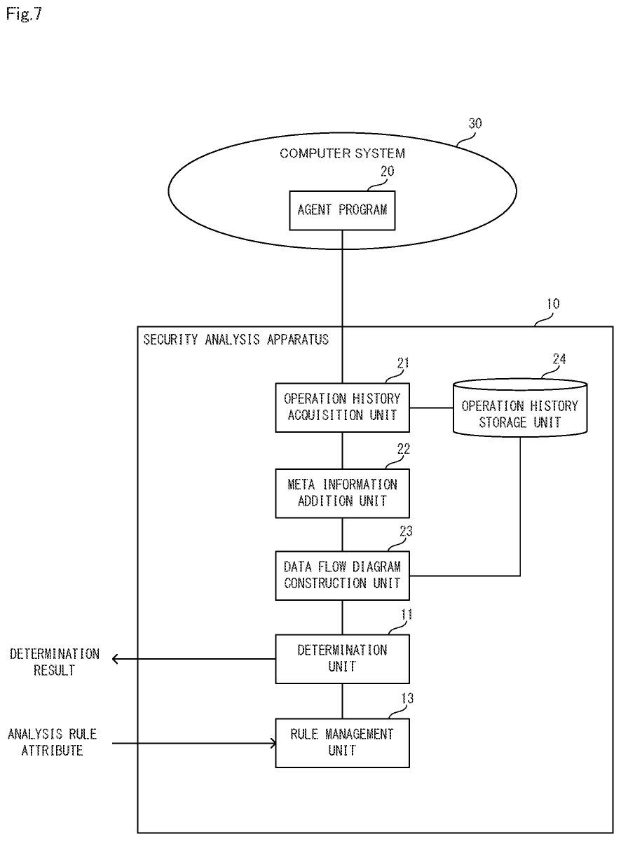

A modification example of the security analysis apparatus 10 in the example embodiment will be described with reference to FIG. 7. FIG. 7 is a configuration diagram illustrating a modification example of the security analysis apparatus in the example embodiment.

As illustrated in FIG. 7, in the modification example, the security analysis apparatus 10 is connected via a network to a computer system 30 to be analyzed. The computer system 30 has an agent program 20 installed therein.

In addition, in the modification example, as illustrated in FIG. 7, the security analysis apparatus 10 includes an operation history acquisition unit 21 instead of the data acquisition unit 12, a meta information addition unit 22, a data flow diagram construction unit 23, and an operation history storage unit 24.

When analysis is requested by the user of the security analysis apparatus 10, the operation history acquisition unit 21 instructs the agent program 20 to collect operation histories. Examples of the operation histories include operation histories of a system call, file permission settings, system snapshots of network interface card (NIC) information, and the like. The operation history acquisition unit 21 stores the collected operation history data in the operation history storage unit 24.

The data flow diagram construction unit 23 acquires the operation history data stored in the operation history storage unit 24 and constructs a data flow diagram for each test scenario based on the acquired data. Specifically, the data flow diagram construction unit 23 extracts a process, a source, and a sink from the operation history data in accordance with a preset test scenario. The data flow diagram construction unit 23 then applies the extracted information to a data flow diagram creation rule and constructs a data flow diagram for each test scenario.

The data flow diagram construction unit 23 also sets data names for the constructed data flow diagrams, and associates the data flow diagrams with meta attributes to create a management table (see FIG. 4). The data flow diagram construction unit 23 then stores the data flow diagrams and the management table in the operation history storage unit 24.

The meta information addition unit 22 adds the meta attribute specified by the user to the data flow diagram constructed by the data flow diagram construction unit 23. Not that the meta information addition unit 22 may notify the data flow diagram construction unit 23 of the meta attribute to be added before the construction of the data flow diagram.

The configurations and functions of a determination unit 11 and a rule management unit 13 are similar to the examples described above. In the modification example, the determination unit 11 searches a data flow diagram constructed by the data flow diagram construction unit 23 and determines the relationship between the data flow diagram and the analysis rule based on the retrieved information.

According to the modification example, it is possible to automatically execute processing from creation of data flow diagrams to determination of the relationship between data flow diagrams and analysis rules.

### Physical Configuration

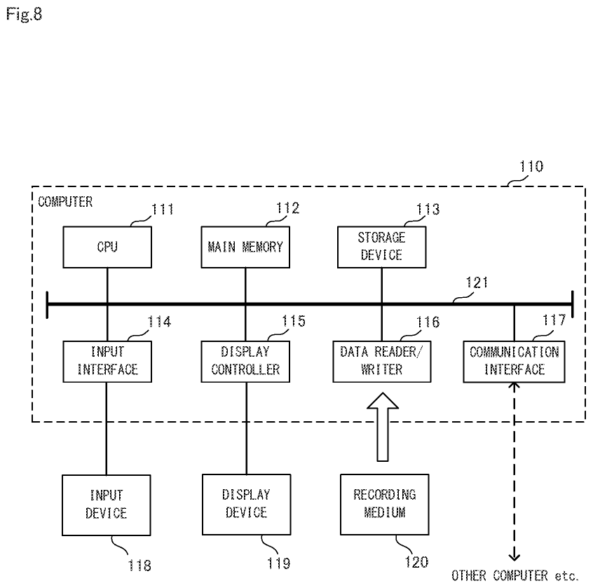

Using FIG. 8, the following describes a computer that realizes the security analysis apparatus 10 by executing the program according to the example embodiment. FIG. 8 is a block diagram illustrating an example of a computer that realizes the security analysis apparatus according to the example embodiment.

As illustrated in FIG. 8, a computer 110 includes a CPU (Central Processing Unit) 111, a main memory 112, a storage device 113, an input interface 114, a display controller 115, a data reader/writer 116, and a communication interface 117. These components are connected in such a manner that they can perform data communication with one another via a bus 121.

The computer 110 may include a GPU (Graphics Processing Unit) or an FPGA (Field-Programmable Gate Array) in addition to the CPU 111, or in place of the CPU 111. In this case, the GPU or the FPGA can execute the program according to the example embodiment.

The CPU 111 deploys the program according to the example embodiment, which is composed of a code group stored in the storage device 113 to the main memory 112, and carries out various types of calculation by executing the codes in a predetermined order. The main memory 112 is typically a volatile storage device, such as a DRAM (dynamic random-access memory).

Also, the program according to the example embodiment is provided in a state where it is stored in a computer-readable recording medium 120. Note that the program according to the first and second example embodiment may be distributed over the Internet connected via the communication interface 117.

Also, specific examples of the storage device 113 include a hard disk drive and a semiconductor storage device, such as a flash memory. The input interface 114 mediates data transmission between the CPU 111 and an input device 118, such as a keyboard and a mouse. The display controller 115 is connected to a display device 119, and controls display on the display device 119.

The data reader/writer 116 mediates data transmission between the CPU 111 and the recording medium 120, reads out the program from the recording medium 120, and writes the result of processing in the computer 110 to the recording medium 120. The communication interface 117 mediates data transmission between the CPU 111 and another computer.

Specific examples of the recording medium 120 include: a general-purpose semiconductor storage device, such as CF (CompactFlash®) and SD (Secure Digital); a magnetic recording medium, such as a flexible disk: and an optical recording medium, such as a CD-ROM (Compact Disk Read Only Memory).

Note that the security analysis apparatus 10 according to the example embodiment can also be realized by using items of hardware, such as a circuit that respectively correspond to the components rather than the computer in which the program is installed. Furthermore, a part of the security analysis apparatus 100 may be realized by the program, and the remaining part of the security analysis apparatus 10 may be realized by hardware.

A part or an entirety of the above-described example embodiment can be represented by (Supplementary Note 1) to (Supplementary Note 15) described below but is not limited to the description below:

### Supplementary Note 1

A security analysis apparatus comprising:
a determination unit that searches for information described in a data flow diagram of a computer system to be analyzed, using a search query corresponding to an analysis rule for use in analysis, and determines a relationship between the data flow diagram and the analysis rule based on retrieved information.

### Supplementary Note 2

The security analysis apparatus according to supplementary note 1, wherein
the data flow diagram is constructed for each test scenario of the computer system,
attribute information for each of the test scenarios is added to the data flow diagram constructed for each of the test scenarios,
the analysis rule has an attribute added thereto, and
the determination unit compares the attribute added to the analysis rule for use in analysis with the attribute information for each of the test scenarios, determines test scenarios to be analyzed, and searches the data flow diagrams corresponding to the determined test scenarios using the search query.

### Supplementary Note 3

The security analysis apparatus according to supplementary note 2, wherein the determination unit cross-searches the data flow diagrams corresponding to the determined test scenarios using the search query.

### Supplementary Note 4

The security analysis apparatus according to supplementary note 2, wherein the determination unit groups the determined test scenarios based on the attribute added to the analysis rule for use in analysis, searches the corresponding data flow diagrams, per group, with the search query, compares search results of the groups, and determines the relationship between the corresponding data flow diagrams and the analysis rule.

### Supplementary Note 5

The security analysis apparatus according to supplementary note 2, wherein the determination unit searches each of the data flow diagrams corresponding to each of the determined test scenarios, and determines the relationship between the corresponding data flow diagrams and the analysis rule based on information retrieved from each of the data flow diagrams.

### Supplementary Note 6

A security analysis method comprising:
searching for information described in a data flow diagram of a computer system to be analyzed, using a search query corresponding to an analysis rule for use in analysis; and
determining a relationship between the data flow diagram and the analysis rule based on retrieved information.

### Supplementary Note 7

The security analysis method according to supplementary note 6, wherein
the data flow diagram is constructed for each test scenario of the computer system,
attribute information for each of the test scenarios is added to the data flow diagram constructed for each of the test scenarios, and
the analysis rule has an attribute added thereto,
the method further comprising:
comparing the attribute added to the analysis rule for use in analysis with the attribute information for each of the test scenarios;
determining the test scenarios to be analyzed; and
searching the data flow diagrams corresponding to the determined test scenarios using the search query.

### Supplementary Note 8

The security analysis method according to supplementary note 7, further comprising:
cross-searching the data flow diagrams corresponding to the determined test scenarios using the search query.

### Supplementary Note 9

The security analysis method according to supplementary note 7, further comprising:
grouping the determined test scenarios based on the attribute added to the analysis rule for use in analysis;
searching the corresponding data flow diagrams, per group, with the search query;
comparing search results of the groups; and
determining the relationship between the corresponding data flow diagrams and the analysis rule.

### Supplementary Note 10

The security analysis method according to supplementary note 7, further comprising:
searching each of the data flow diagrams corresponding to each of the determined test scenarios; and
determining the relationship between the corresponding data flow diagrams and the analysis rule based on information retrieved from each of the data flow diagrams.

### Supplementary Note 11

A computer readable recording medium that includes a program recorded thereon, the program including instructions that causes a computer to carry out:
searching for information described in a data flow diagram of a computer system to be analyzed, using a search query corresponding to an analysis rule for use in analysis; and
determining a relationship between the data flow diagram and the analysis rule based on retrieved information.

### Supplementary Note 12

The computer readable recording medium according to supplementary note 11, wherein
the data flow diagram is constructed for each test scenario of the computer system,
attribute information for each of the test scenarios is added to the data flow diagram constructed for each of the test scenarios, and
the analysis rule has an attribute added thereto,
the program further including instructions that causes the computer to carry out:
comparing the attribute added to the analysis rule for use in analysis with the attribute information for each of the test scenarios;
determining the test scenarios to be analyzed; and
searching the data flow diagrams corresponding to the determined test scenarios using the search query.

### Supplementary Note 13

The computer readable recording medium according to supplementary note 12, the program further including instructions that causes the computer to carry out:
cross-searching the data flow diagrams corresponding to the determined test scenarios using the search query.

### Supplementary Note 14

The computer readable recording medium according to supplementary note 12, the program further including instructions that causes the computer to carry out:
grouping the determined test scenarios based on the attribute added to the analysis rule for use in analysis;
searching the corresponding data flow diagrams, per group, with the search query:
comparing search results of the groups; and
determining the relationship between the corresponding data flow diagrams and the analysis rule.

### Supplementary Note 15

The computer readable recording medium according to supplementary note 12, the program further including instructions that causes the computer to carry out:
searching each of the data flow diagrams corresponding to each of the determined test scenarios; and
determining the relationship between the corresponding data flow diagrams and the analysis rule based on information retrieved from each of the data flow diagrams.

Although the invention of the present application has been described above with reference to the example embodiment, the invention of the present application is not limited to the above-described example embodiment. Various changes that can be understood by a person skilled in the art within the scope of the invention of the present application can be made to the configuration and the details of the invention of the present application.

### INDUSTRIAL APPLICABILITY

According to the present disclosure, it is possible to enable automatization of security checks based on analysis rules in a computer system. The present disclosure is useful for computer systems that perform security checks using analysis rules.

### REFERENCE SIGNS LIST

10 Security analysis apparatus
11 Determination unit
12 Data acquisition unit
13 Rule management unit
20 Agent program
21 Operation history acquisition unit
22 Meta information addition unit
23 Data flow diagram construction unit
24 Operation history storage unit
30 Computer system
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A security analysis apparatus comprising:
at least one memory storing instructions; and
at least one processor configured to execute the instructions to:
search for information described in a data flow diagram of a computer system to be analyzed, using a search query corresponding to an analysis rule for use in analysis, and
determine a relationship between the data flow diagram and the analysis rule based on retrieved information.

2. The security analysis apparatus according to claim 1, wherein
the data flow diagram is constructed for each test scenario of the computer system,
attribute information for each of the test scenarios is added to the data flow diagram constructed for each of the test scenarios,
the analysis rule has an attribute added thereto, and
further at least one processor configured to execute the instructions to:
compare the attribute added to the analysis rule for use in analysis with the attribute information for each of the test scenarios, determine test scenarios to be analyzed, and search the data flow diagrams corresponding to the determined test scenarios using the search query.

3. The security analysis apparatus according to claim 2, wherein
further at least one processor configured to execute the instructions to:
cross-search the data flow diagrams corresponding to the determined test scenarios using the search query.

4. The security analysis apparatus according to claim 2, wherein
further at least one processor configured to execute the instructions to:
group the determined test scenarios based on the attribute added to the analysis rule for use in analysis,
search the corresponding data flow diagrams, per group, with the search query,
compare search results of the groups, and
determine the relationship between the corresponding data flow diagrams and the analysis rule.

5. The security analysis apparatus according to claim 2, wherein
further at least one processor configured to execute the instructions to:
search each of the data flow diagrams corresponding to each of the determined test scenarios, and
determine the relationship between the corresponding data flow diagrams and the analysis rule based on information retrieved from each of the data flow diagrams.

6. A security analysis method comprising:
searching for information described in a data flow diagram of a computer system to be analyzed, using a search query corresponding to an analysis rule for use in analysis; and
determining a relationship between the data flow diagram and the analysis rule based on retrieved information.

7. The security analysis method according to claim 6, wherein
the data flow diagram is constructed for each test scenario of the computer system,
attribute information for each of the test scenarios is added to the data flow diagram constructed for each of the test scenarios, and
the analysis rule has an attribute added thereto,
the method further comprising:
comparing the attribute added to the analysis rule for use in analysis with the attribute information for each of the test scenarios;
determining the test scenarios to be analyzed; and
searching the data flow diagrams corresponding to the determined test scenarios using the search query.

8. The security analysis method according to claim 7, further comprising:
cross-searching the data flow diagrams corresponding to the determined test scenarios using the search query.

9. The security analysis method according to claim 7, further comprising:
grouping the determined test scenarios based on the attribute added to the analysis rule for use in analysis;
searching the corresponding data flow diagrams, per group, with the search query;
comparing search results of the groups; and
determining the relationship between the corresponding data flow diagrams and the analysis rule.

10. The security analysis method according to claim 7, further comprising:
searching each of the data flow diagrams corresponding to each of the determined test scenarios; and
determining the relationship between the corresponding data flow diagrams and the analysis rule based on information retrieved from each of the data flow diagrams.

11. A non-transitory computer readable recording medium that includes a program recorded thereon, the program including instructions that causes a computer to carry out:
searching for information described in a data flow diagram of a computer system to be analyzed, using a search query corresponding to an analysis rule for use in analysis; and
determining a relationship between the data flow diagram and the analysis rule based on retrieved information.

12. The non-transitory computer readable recording medium according to claim 11, wherein
the data flow diagram is constructed for each test scenario of the computer system,
attribute information for each of the test scenarios is added to the data flow diagram constructed for each of the test scenarios, and
the analysis rule has an attribute added thereto,
the program further including instructions that causes the computer to carry out:
comparing the attribute added to the analysis rule for use in analysis with the attribute information for each of the test scenarios;
determining the test scenarios to be analyzed; and
searching the data flow diagrams corresponding to the determined test scenarios using the search query.

13. The non-transitory computer readable recording medium according to claim 12, the program further including instructions that causes the computer to carry out:
cross-searching the data flow diagrams corresponding to the determined test scenarios using the search query.

14. The non-transitory computer readable recording medium according to claim 12, the program further including instructions that causes the computer to carry out:
grouping the determined test scenarios based on the attribute added to the analysis rule for use in analysis;
searching the corresponding data flow diagrams, per group, with the search query;
comparing search results of the groups; and
determining the relationship between the corresponding data flow diagrams and the analysis rule.

15. The non-transitory computer readable recording medium according to claim 12, the program further including instructions that causes the computer to carry out:
searching each of the data flow diagrams corresponding to each of the determined test scenarios; and
determining the relationship between the corresponding data flow diagrams and the analysis rule based on information retrieved from each of the data flow diagrams.
